(19) United States
(12) Patent Application Publication
(10) Pub. No.: US 2024/0192698 A1
(43) Pub. Date: Jun. 13, 2024

(54) METHOD OF SELF-LOCALIZATION IN A NAVIGATION ENVIRONMENT AND SELF-LOCALIZING VEHICLE

(71) Applicant: SICK AG, Waldkirch (DE)

(72) Inventors: Christoph HOFMANN, Waldkirch (DE); Alfred AROCKIARAJ, Waldkirch (DE)

(21) Appl. No.: 18/537,732

(22) Filed: Dec. 12, 2023

(30) Foreign Application Priority Data
Dec. 13, 2022 (EP) 22213136.9

(51) Int. Cl. G05D 1/244; G06F 16/955; G06K 7/14; G06K 19/06

(52) U.S. Cl. CPC G05D 1/2446; G06F 16/9554; G06K 7/1417; G06K 19/06037; G05D 2111/10

(57) ABSTRACT

A method of self-localization in a navigation environment is provided in which a respective optical marker is attached to a plurality of positions, wherein a marker is detected and read by an optical code reader and the position of the marker is determined from the code content. In this respect, the markers are attached in groups of at least three respective markers; a value range of the code content of the markers is smaller than the number of positions having an optical marker; and the code content of the at least three markers of a group together uniquely describe the position of the group.

The invention relates to a method of self-localization in a navigation environment and to a self-localizing vehicle respectively.

A requirement for successful navigation is a reliable knowledge of an object's own position by self-localization. Satellite supported processes (GPS, global positioning system) are available for this purpose in the outdoor area. There are alternative processes in the indoor area without any reception of satellite signals that are based on a plurality of stationary transmitters in different technologies such as ultrasound, radar, or also wireless LAN or mobile radio. As a rule, however, no infrastructure designed for this is available. There are furthermore image based processes such as SLAM (simultaneous localization and mapping) that require very high quality sensor systems and algorithm systems, above all when the error quota should remain small. Navigation above all in the indoor area is thus a very complex task that requires a high and/or expensive effort. The difficulties become even greater when an adaptation to new situations and scenarios is required.

Self-localization can conventionally be supported by artificial optical markers. It is, for example, known to record positions of artificial markers on a map. A marker can furthermore communicate its own position by means of optical codes. There are additionally processes that determine the pose of a camera detecting the marker. In particular so-called fiducial markers that provide sufficient features to reconstruct the pose are suitable for the latter. In the simplest case, the features are the four corners of the marker, with additional robustness, including the possibility of error recognition, being able to be provided by further internal features of the marker.

A known vision system based on fiducial markers is AprilTag, see https://april.eecs.umich.edu/software/apriltag.html, including a list of literature shown there. It comprises a library implemented in C having inter alia functions for determining the 3D position, orientation, and identity of the markers. An alternative is ArUco with a tutorial at https://docs.opencv.org/4.x/d5/dae/tutorial_aruco_detection.html. VUMarks provides a further class of special artificial markers, see https://library.vuforia.com/objects/vumarks.

U.S. Pat. No. 10,417,469 B2 discloses a system for navigation with self-describing fiducial markers that communicate information supporting the navigation, including the marker's own position, in an optical manner. There is furthermore the possibility of accessing a database based on the self-description and thus to obtain additional information.

A method of managing a warehouse in which autonomous vehicles move is presented in U.S. Pat. No. 10,223,666 B1. They orient themselves using fiducial markers that are recorded in a reference map. The value range of the fiducial markers is small so that there are initially ambiguities with regard to the identity of a detected fiducial marker. The ambiguity is resolved by additional properties such as different colors, orientations, or sizes of the fiducial markers.

Different geocoding processes are known to describe a location, which for example, include mail addresses that are, however, not suitable for indoor navigation and not even for navigation outside municipalities. A particular geocoding process has the name What3Words and is described, for example, in WO 2014/170646 A1. A fixed dictionary is here associated with every location with a resolution of approximately 3 meters. The European Patent Office in Munich, for example, resides at ///truck.piston.arrival. There is no obvious traceability of the three words associated with a location and nor is there any simple neighborhood relationships. What3Numbers at https://github.com/hfu/what3numbers uses a similar principle with three numbers instead of three words. Mapcode uses two groups of letters and numerals, optionally with a country code; the address of the European Patent Office here becomes Deu C57.MB.

Such codes are, however, purely abstract and only accessible via computer systems. There is no possibility of breaking down the What3Words code content using a sensor system on site and thereby of learning one's own position. Only by the reverse can the position be determined by means of GPS, for example, and the associated code can then be queried, with, however, self-localization not being supported, but rather again only being based on GPS. There is furthermore no possibility of integrating one's own indoor area in a self-selected division into such a system.

The not yet published European patent application bearing the reference number 22193749.3 describes a camera device that determines its pose with respect to an optical marker, in particular a fiducial marker, in a safe manner by using two camera channels. The camera device can thus localize itself relative to the marker; however, this does not contribute to a solution to the problem of determining the position of the marker oneself.

It is therefore the object of the invention to further improve self-localization by optical markers.

This object is satisfied by a method of self-localization in a navigation environment and by a self-localizing vehicle in accordance with the respective independent claim. The navigation environment can be arbitrary, with the method being particularly suitable for the indoor area where no satellite supported localization method is available. Optical markers are applied at a plurality of positions of the navigation environment. A code reader detects a marker in its field of view and reads the code content of the marker to thus determine the position of the marker. Every device known per se for this purpose can be considered as the code reader, for example a camera. Effectively only the code reader is effectively localized, but thus also indirectly its carrier, preferably an autonomous vehicle or a mobile rotor (AMR, autonomous mobile robot).

The invention starts from the basic idea of combining optical markers in groups of at least three markers. Every single marker has only a limited value range; there are therefore fewer and preferably a great deal fewer distinguishable individual markers than positions with markers. For example, a single marker only encodes one numeral, one letter, or only a two-digit number, with numerical code content being preferred while hundreds, thousands, or even a great deal more positions having to be distinguished. Only the code content of the at least three markers of a group together uniquely describe a position. The code content is preferably combined into a combination code for this purpose. The groups of respectively exactly three markers are preferably formed as an optimum between a small number of markers and a sufficient number of uniquely coded groups. An illustrative description of this idea against the background of the prior art according to What3markers discussed in the introduction.

The method is computer implemented; for example, it runs in the code reader, on a processing unit also connected by means of a network or via a cloud, or, for example, in a vehicle controller, with a distributed implementation being possible. Only the optical detection of the markers has to take place on site; all the further processing can be outsourced. It is, however, advantageous to at least carry out the decoding on site, that is in the code reader or at least the carrier of the code reader, so that the information to be exchanged with external remains limited.

The invention has the advantage that a particularly cost-favorable and at the same time very robust form of self-localization is made possible. Since the codes only have a small value range, for example only one numeral, a very simple camera is sufficient to read the code content. Its images can simultaneously be used for other work, for example for obstacle recognition. A large navigation environment is nevertheless accessible with high spatial resolution due to the principle of the three markers in a group. The size of the navigation environment and the spatial resolution can even be very simply scaled via the density of the markers. The self-localization is possible in one dimension, for example along a rail, in two dimensions, and also in three dimensions in a building having multiple stories or high shelves. Complex technical solutions such as indoor GPS or systems based thereon such as navigation by ultrasound, radar, wireless LAN, or mobile radio are just as less necessary as complex algorithms for localization and mapping (SLAM, for instance). The concept allows a kind of swarm intelligence for a plurality of vehicles in the same navigation environment. A connection to superior systems, for instance for warehouse management, for risk analysis, or for data analysis and the optimization of routes and other processes is easily possible.

The navigation environment is preferably divided into a plurality of cells, in particular in a grid, with a respective group of markers being associated with the cells. A desired position resolution can be specified over the cells. The cells are preferably regular and of equal size, as is in particular the case with a grid. In a different manner, cells can also be individual or irregular or positions having a respective group of markers can be arranged as desired. It is conceivable in a grid to leave at least one cell without a group of markers, particularly when the attachment of markers is not possible at some points. As explained below, however, a group of markers can provide information on the environment, indeed also over a cell without its own group of markers.

A pose of the code reader is preferably determined with respect to a detected marker to determine an offset from the position described by the group of markers. The code reader thus localizes itself relative to the group of markers in up to six degrees of freedom of the position and rotation. A respective optical marker preferably has at least three reference features of known positions within the optical marker. It is in particular a fiducial marker (fiducial, frame marker). The three reference features allow the pose determination in the manner of a tripod in that they determine a 2D geometry in space, with four or even more reference features preferably being provided for a redundant pose determination that is more robust overall. Fiducial markers are known per se and reference is additionally made to the compliance. On the one hand, the position of the group of markers is known from their code content; on the other hand, the relative position of the code reader with respect to the marker, and thus overall the exact position of the code reader and thus of its carrier, are known by determining the pose. The installation position of the code reader with respect to the carrier should be taken into account here. A camera having distance determination, i.e. a 3D camera, is particularly suitable for the determination of the pose of the code reader with respect to a detected marker. Any desired 3D process known per se is suitable for this, for example stereoscopy based on human vision, triangulation processes for a known projected illumination pattern, or image sensors using time of flight (ToF) measurement in their pixels.

The pose is preferably determined multiple times for a plurality of, in particular all of, the markers of a group. Every marker is per se suitable to determine the relative pose of the code reader with respect to the marker. Every group therefore provides a plurality of possibilities for position determination. An average pose can then subsequently be formed.

The code content of the at least three markers of a group is preferably combined into at least one triple tuple. The code content thus forms a combination code; in the preferred optimum case having three markers per group, a triple tuple or triplet. It can be noted as Codecontent1.Codecontent2. Codecontent3; correspondingly in the preferred case of numerals or two-digit numbers c1.c2.c3 with c1 . . . c3 as a numeral or a two-digit number. It must be noted that these are coordinates at most in the virtual parameter space of the possible unique descriptors that preferably have nothing to do with global coordinates. It is then not possible to draw a conclusion on a spatial proximity from a small difference between two combination codes. The triplets are unique, but preferably without an intuitively retraceable order. The order particularly preferably does not play any role; there is therefore no difference between c1.c2.c3 and c2.c3.c1, and the order within the group does not have to be considered either in the attachment or in the reading of the markers. This corresponds in the combination system of combination codes to a drawing without putting back and would be absolutely inconceivable for conventional global coordinates. It is alternatively conceivable that the order is nevertheless important. In this case, a symmetry breaker for a respective group can be attached and recognized, that is an additional optical marker that specifies a reading direction.

The code content of at least one marker of a group preferably contains a further piece of information that goes beyond the unique naming of the position by the other markers of the group. There are then so-to-say two code families in the navigation environment, namely the groups of at least three markers in accordance with the invention, on the one hand, and additional optical markers that can be attached with the group. The additional information is not used for the previously explained self-localization it can, for example, relate to other navigation instructions or information for a different application than the navigation. It is furthermore conceivable that a marker satisfies a dual function in both code families. A different appearance is conceivable here such as a different color, a different size, or the like so that the marker of the second code family can additionally act as a symmetry breaker. The further information can, however, simply be found in the appearance of the at least one marker that is in particular larger to facilitate a pose determination.

The markers are preferably at least partially displayed on a variable display. A tablet, electronic paper, or the like can serve for this purpose. A variable display makes it possible to switch between optical markers, for example for an emergency such as a fire alarm. Alternatively, the markers are unchangeable once applied, typically in the form of stickers.

Additional information is preferably invoked from a database using the code content of the at least three markers of a group. The information content of a group is sufficient to locate a unique position in the navigation environment. There is, however, frequently a need to learn more about the group or the position. This could only be encoded in the markers in an extremely limited manner and would also contradict the idea of simple markers. However, a database query can be implemented via the unique group or the combination code or the triplet of the code information by which the limitation of the amount of information is canceled for practical purposes. The database is preferably external, in particular in a cloud. At least some of the database can be stored in the code reader or its carrier, for example in a vehicle, with this also being able to be set up successively or temporarily as a buffer of earlier queries and results. A certain independence is thus produced in at least a closer environment or on frequently traveled paths. A comparison should then, however, regularly take place for an advantageous embodiment still to be described with a dynamic database.

The database provides at least one piece of the following group information to a position described by a group of at least three markers: a closer description of the position or its environment, an offset of the group of at least three markers from the position described thereby, at least one navigation rule. It is called group information because it is associated with a group and thus with a position. The position can be described more accurately with group information, for instance that is the building X or the department Y. An environment description can take place such as indications of obstacles or hazards in specific directions, but also a local map with adjacent cells and groups or markers there or their combination codes. A possible piece of group information indicates an offset of the encoded position from the actual position of the group. This makes it possible to attach the markers at an easily visible position or a position only accessible at all within or even outside its cell, in particular deviating from a regular grid. A navigation rule provides instructions for the next movements or actions and the next paragraph provides examples for this. Group information can additionally comprise metadata such as time stamps, management data, or events, for instance on the age of the marker, a history of when and by which unit this group had already been detected, or on the age and origin of navigation rules or the time of their last amendment.

The navigation rule preferably comprises at least one of the following instructions: a direction indication, a distance indication, a speed specification, a prompt to pick or place an object, a prompt to charge a battery. It can therefore be a navigation rule in a narrower sense that specifies certain movements such as move forward, turn left, right, turn round, travel a certain distance, or that restricts the movements, for instance with respect to a speed or acceleration framework. Other actions are, however, also conceivable that are related to the navigation, for instance the instruction to follow a specific object, to wait a certain time or for a certain event, to pick something up or place it down, or to charge the battery at a charging station.

At least one piece of group information of the database is preferably dynamically varied, in particular to respond to a current task, to persons, or to vehicles in the navigation environment. This makes a flexible, situation related navigation possible. Variable information can thus effectively be associated with fixed optical markers via the indirection of the dynamic database which is accessed via the group of markers or their triplet of the code information or combination code. A task can thus be set differently or can respond to vehicles or persons in the navigation environment, in particular to adapt the vehicles in a situation related manner.

A self-localizing vehicle in accordance with the invention, in particular an autonomous vehicle or a mobile robot, moves in a navigation environment in which positions are marked by groups of at least three markers. The vehicle and the navigation environment provided with the markers thus together form a common system. A control and performance unit, for example the vehicle controller, is configured for a self-localization and navigation by reading the codes of a group and determining the position uniquely described by them, in particular by an embodiment of the method in accordance with the invention. The functionality of the control and performance unit can be distributed over the code reader, the vehicle, and connected processing units, in particular a cloud.

The invention will be explained in more detail in the following also with respect to further features and advantages by way of example with reference to embodiments and to the enclosed drawing. The Figures of the drawing show in:

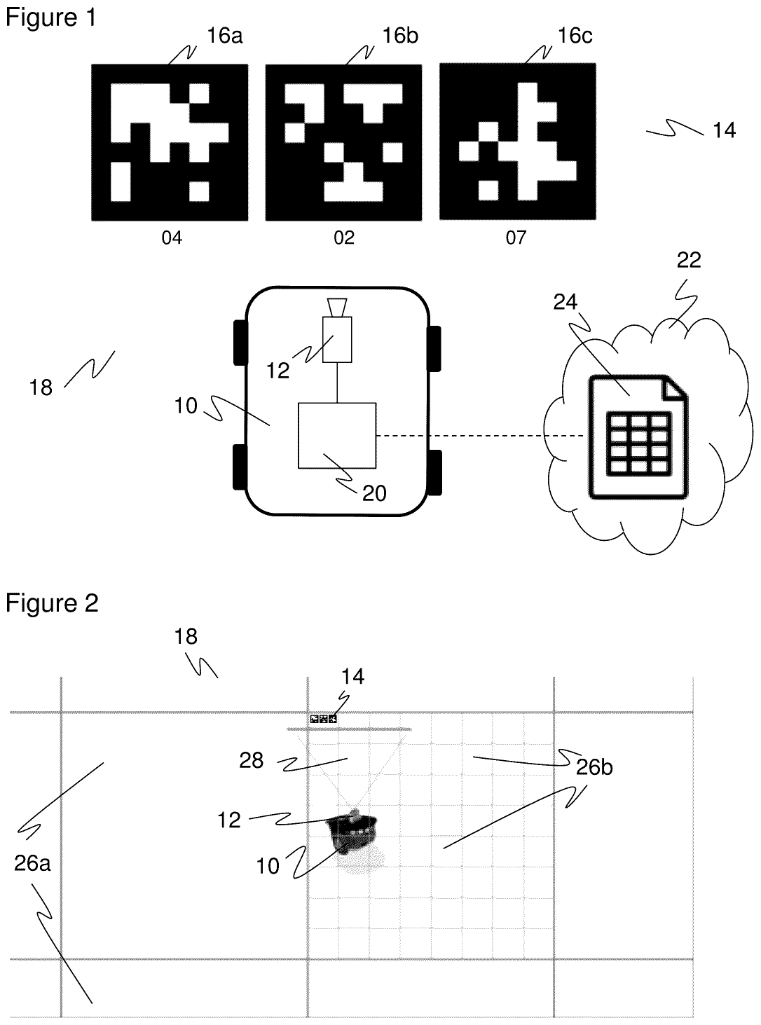

FIG. 1 a schematic representation of a vehicle as an exemplary carrier of a code reader for detecting a group of optical markers from whose code content a position is determined;

FIG. 2 a schematic representation to illustrate the division of a navigation environment into cells with a respective group of optical markers;

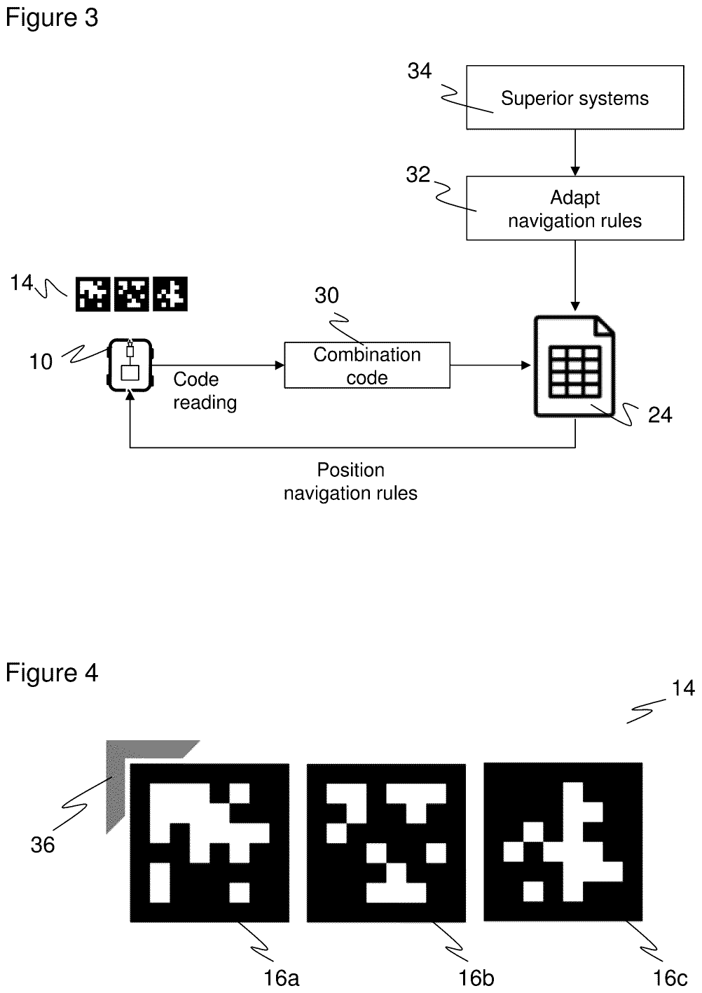

FIG. 3 a schematic representation of the communication links of a vehicle with a code reader corresponding to FIG. 1 and a database connected thereto;

FIG. 4 an exemplary representation of a group of optical markers with an additional symmetry breaker;

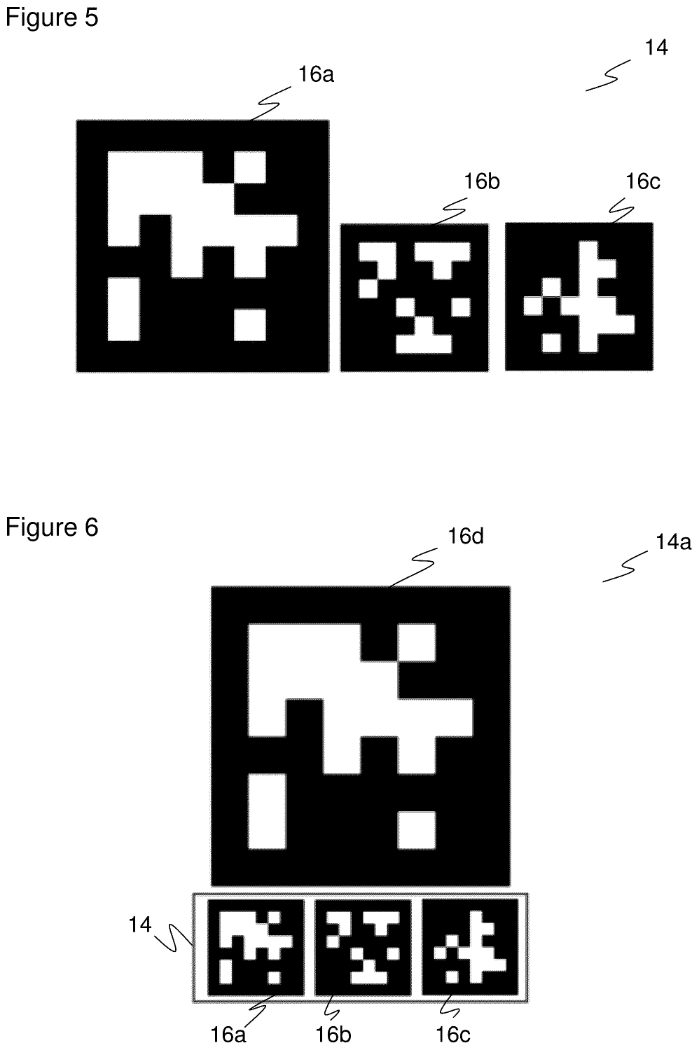

FIG. 5 an exemplary representation of a group of optical markers from two code families; and

FIG. 6 an exemplary representation of an alternative group of optical markers from two code families;

FIG. 1 shows a schematic representation of a vehicle 10 having a code reader 12 for detecting a group 14 of optical markers 16a-c from whose code content a position of the code reader 12 and also of the vehicle 10, while taking account of its installation pose, is determined. The vehicle 10 is, for example, an autonomous vehicle (AGV, automated guided vehicle) or a mobile robot (AMR, autonomous mobile robot) and is here representative for any desired carrier of the code reader 10, with this carrier also being able to be a person in principle. A self-localization of the vehicle 10 takes place by means of the group 14 of optical markers 16a-c.

The self-localization, that is the knowledge of an object's own position in a navigation environment 18, then in turn makes navigation of the vehicle 10 possible. Examples for the navigation environment 18 in the indoor area are logistics centers, factories, management buildings, airport buildings, hospitals, exhibitions, or also vertical farming. The application is also initially not restricted in the outdoor area, but is above all directed to restricted areas not covered by conventional geocodes such as mail addresses such as ports, airports, loading zones of logistic centers, or agricultural areas or vines.

The code reader 12 can be configured as a simple camera as shown with an image sensor, not shown separately, that is preferably configured as a matrix-like recording chip and records a rectangular pixel image, for example a CCD or CMOS sensor. The code content of a marker 16a-c is then read using image processing methods known per se. The invention is not restricted to a specific code reader 12 as long as the markers 16a-c used are read. The image recording can take place as a secondary function of any desired image recording device, for instance an onboard camera for obstacle recognition or a carried tablet or cellphone.

A control and evaluation unit 20 is connected to the code reader 12. It is a vehicle controller in FIG. 1. In general, however, any desired carried processing units or processing units connected by means of a preferably wireless network connection are possible that are based on the most varied hardware, for example on one or more digital modules such as microprocessors, ASICs (application specific integrated circuits), FPGAS (field programmable gate arrays), GPUs (graphics processing units), or mixed forms thereof, with the digital modules being able to be at least partly integrated in the code reader 12. An edge device or, as shown, a cloud 22 can in particular be named as external processing units. The control and evaluation functionality can be distributed as desired over these elements, with preferred work divisions being explained below with reference to FIG. 3. AprilTags are used as markers 16a-c by way of example, with other optical codes likewise being conceivable. However, fiducial markers are preferred since they simplify the determination of a relative pose of the code reader 12 to the markers 16a-c. Such markers are also read substantially more robustly. The introduction names further examples for optical codes and fiducial markers. The code content of a respective marker 16a-c is a numeral or a number; in the example shown they are the numbers 04, 02, and 07. The value range of numerals or also of two-digit numbers is much too small to characterize a significantly large navigation environment 18 with a usable spatial resolution by unique individual markers 16a-c. Large numbers in turn make code reading more difficult so that it would no longer be possible to work with simple code readers 12, larger ranges, poor visibility, and the like.

The markers 16a-c are therefore combined in groups 14. They are preferably groups of three or triplets, but the number k=3 is not fixed initially. The group 14 together exponentially expands the effective value range in which positions can be uniquely described. The individual code content of the markers 16a-c is combined to form a combination code or triplet; in the example of FIG. 1 04.02.07 in any desired syntax. This can be called “What3markers” based on the prior art cited in the introduction.

Depending on the embodiment, the order of the markers 16a-c and of their code content can play a role or not, with the latter facilitating the detection since no orientations or reading directions have to be considered. With a value range of n, for instance n=10 for a numeral, for the individual markers 16a-c and a number k, for instance k=3, of markers 16a-c per group, unique combination codes corresponding to a drawing with/without putting back result from the c while taking account of the order n^{k} and without taking account of the order. (ₖⁿ). n=587 applies to the AprilTag family “36h11” so that 201,229,470 unique combination codes can be formed from three corresponding markers 16a-c even in the somewhat less favorable case with respect to the combination system without considering the order. This is enough for an area of approximately 201 km² with one respective group 14 per m². If the number of available combination codes is nevertheless not sufficient, there is the possibility of providing navigation environments 18 with superior codes such as “X” stories in “Y” buildings in “Z” countries. This also has the advantage that large datasets can be combined and evaluated across locations.

The combination code uniquely describes a position, but does so in a format unusable for the navigation. For the distribution of the combination codes over the navigation environment 18 preferably does not take place in accordance with the geometrical arrangement at all, but rather in accordance with internal criteria, a history with continuously subsequently attached groups 14, or even with the direct demand of keeping spatially adjacent groups 14 as different as possible to avoid confusion. In embodiments in which the order of the markers 16a-c is not observed, it is immediately clear that there can be no sensible geometrical relationship between the combination code and the position in the sense of spatial coordinates.

To arrive at processable position information, the control and evaluation unit 20 therefore preferably queries the associated unique position in a database 24 with the combination code. The database 24 is preferably implemented in a cloud 22, but can alternatively also be carried in the vehicle 10. The database 4 also cancels the restriction of the information content of optical markers since any further group information can be provided for the combination code. Group information means that this information is associated with the group and thus the position. This can in particular include navigation rules. The group 14 then acts as a kind of traffic controller.

The markers 16a-c are preferably permanently arranged in the navigation environment 18. Stickers that can be correspondingly printed are suitable for this. Alternatively, electronic displays are conceivable such as tablets or eBook readers with which the displayed markers 16a-c are dynamically variable. Different markers 16a-c or completely different information can, for example, be displayed during servicing or in an emergency that can also serve a diagnosis or the initial setup of the system. Electronic displays are primarily directed to persons. In a functioning system with an automatic routine, changes are preferably made via the database 234, i.e. the markers 16a-c and thus the combination codes then remain the same, but the group information stored with respect to them can change.

FIG. 2 shows a schematic representation to illustrate the division of a navigation environment 18 into cells 26a-b with a respective group 14 of optical markers 16a-c. Scalable divisions into regular grids or also irregular grids 26a-b are possible as shown by two alternative sizes with large cells 26a, on the one hand, or small cells 26b, on the other hand. It is conceivable that an automatic distribution of cells 26a-b is made that determines an optimum grid constant or optimally fits an arrangement of cells 26a-b into a navigation environment 18.

The small cells 26b of FIG. 2 can alternatively be understood still differently as the result of a finer division of the navigation environment with more groups 14 of optical markers 16a-c. It is namely possible in some embodiments that the code reader 12 determines its pose relative to a marker 16a-c in up to six degrees of freedom with this making use of where a marker 16a-c was detected within the field of view 28 of the code reader 12. This is preferably done on a use of fiducial markers. AprilTags already contributes a corresponding mechanism for self-localization relative to the marker. A more exact self-localization corresponding to the small cells 26b is then thereby possible even though a group 14 of markers 16a-c is only attached in a respective large cell 26a. Since a group 14 has a plurality of markers 16a-c, the pose can even be determined multiple times with a systematic offset corresponding to the arrangement of the markers 16a-c within their group 14. The pose determination can thus be even more robust by means of averaging or a comparison of individual results.

It is not absolutely necessary that every cell 26a-b is provided with a group 14 of markers 16a-c. This is sometimes not even possible because columns, shelves, doors, and the like are in the way. The vehicle 10 can then determine its position with reference to the pose with respect to a group 14 of markers 16a-c of an adjacent cell 26a-b. A further possibility is that the group 14 of a cell 26a-b is attached outside its cell 26a-b and communicates the offset as group information.

FIG. 3 shows a schematic representation of the communication links of a vehicle 10 corresponding to FIG. 1 whose substructure is only shown in an indicative manner and of the database connected thereto preferably in a cloud. As already explained with reference to FIG. 1, the code reader 12 reads the markers 16a-b of the group by means of corresponding image processing and assembles their code content to a unique combination code 30. The database 24 is queried with the combination code 30 and the unique position is returned. Further group information can be communication, with navigation results being named by way of example. The query via the combination code can optionally be safeguarded by encryption or a checksum such as CRC.

Every combination code 30 in the database 24 forms an entry that links the combination code 30 to the associated unique position and possibly group information. There can be metadata in this respect such as time stamps for read markers 16a-c and combinations codes 30 derived therefrom, time stamps for group information or their change, or which code reader 12 has carried out a query with which image. The mere position can be supplemented by further details of the environment of the respective cell 26a-b, for example where exactly the group 14 is located in its cell 26a-b, in which building, which plant, which country the cell 26a-b is located, what the properties of the environment are, whether with respect to objects that are present, obstacles, hazards, which cells 26a-b are located in the neighborhood, in particular in the form of a local region of interest of a global map, for instance in the form of the eight surrounding cells 26a-b.

Navigation rules that tell the vehicle 10 how it should move or which movement possibilities are available from special group information. They can be indications of direction such as straight ahead, left, right, or back, distance indications with respect to a target or a next movement step, or specifications for speeds or accelerations. Further examples are the prompt to wait a certain time, to move to a certain position, to follow a certain object, to avoid an object, to selected certain travel paths, or actually not to wait, and the like. Navigation rules in a somewhat wider sense trigger an action such as picking or placing objects or charging a battery of the vehicle 10.

The markers 16a-c themselves are fixed. An embodiment having electronic displays was briefly discussed above, but the variability is also limited with this, particularly since the displayable information amount that can be detected by the code reader 12 is preferably at least largely exhausted by the combination code. The system overall can nevertheless be very dynamic in that the database 24 is updated. There is practically no relevant limit for the stored group information in the database 24. The fixed combination code thus opens up access to an adaptable, but still uniquely position related information source. Situative navigation is thereby made possible and indeed not only in the sense that there is certain group information at certain positions, but rather in that even new group information is provided at every certain position. The adaptation of navigation rules is combined in block 32 in FIG. 3 as a common external influence on the database 24. There can actually be different reasons that, contrary to the illustration, can also be due to the cloud 22, the database 24, or the vehicle 10.

The possibility of modifying the navigation rules in a dynamic database is particularly advantageous. There can be many reasons for this such as an optimization of travel paths, the satisfaction of new tasks, safety measures, maintenance work. The adaptation of vehicles appears particularly relevant, for instance in dependence on the number of vehicles 10 or persons in the navigation environment 18, on jams, blocked zones, or other obstacles. If it is known that groups 14 of markers 16a-c are no longer readable, it may be sensible to avoid the corresponding cells 26a-b where possible since self-localization will fail there and navigation is thus at least substantially more difficult.

In particular superior systems 34 have an influence on the navigation rules. Fleet management, dynamic risk assessment (behavior driven risk assessment), or service information can be named by way of example here. Fleet management is responsible for the system working efficiently overall and it therefore accordingly dynamically specifies navigation rules at the individual positions. It can collect the positions of the vehicles 10 and thus coordinate a swarm intelligence. The risk assessment depends, for example, on the number of persons and their current locations and work. Legal specifications that may also apply across countries can also play a role. Environmental information as an example of group information has already been discussed above. It also does not have to be static because objects in the navigation environment 18 change. Virtual objects are even conceivable, in particular walls that are communicated by group information. Partial zones can thereby be temporarily made inaccessible, for instance if presently persons work or carry out maintenance there. It is sensible to store a backup of the database 24 and to keep an account of the changes, in particular safeguarded by a blockchain.

A publish and subscribe mechanism is preferably used as the underlying software architecture here. Every arrow on the database 24 can be interpreted in this sense. The combination code is published. An algorithm subscribes to this information, stores it and determines associated position or group information, in particular navigation rules, from the database 24. This is then conversely published and subscribed to by the vehicle 10 that thus always has current group information and navigation rules. The adaptation of navigation rules at block 32 can likewise be based on publish and subscribe.

An advantageous implementation uses cloud native technologies such as K8s, K3s, or Minikube. To link a cloud 22, an at least indirect connection of the code reader 12 to the internet or to an intranet with the cloud 22 is required. In such cloud native systems, changes to a database 24 from a plurality of sources, the monitoring of such changes, and a reliable forwarding to the relevant subscribers are provided. It is also possible to set which information is forwarded at which times. Some of the database 24 can be stored on the vehicle 10 itself despite the cloud technology to reduce the data traffic and to reduce corresponding latencies. There are possibly also navigation rules that should not be changed due to safety regulations, legal specifications, or a corporate policy, which is either taken into account in the database 24 or is ensured in that the vehicle 10 is aware of such navigation rules and ignores or overwrites specifications of the database 24 where required.

FIG. 4 shows an exemplary representation of a group 14 of optical markers 16a-c with an additional symmetry breaker 36. It designates an optical element by which a desired orientation or reading direction is provided to the group 14. This is in particular of interest if the order of the individual pieces of code information in the combination code is relevant. The specific graphical design of the symmetry breaker 36 is purely by way of example and any desired design elements, including corporate logos and the like, can be used for it.

FIG. 5 shows an exemplary representation of a group 14 of optical markers 16a-c from two code families. It is meant by this that at least one of the optical markers 16a has an additional function that is not exhausted in the contribution to the combination code. It is possible that the code content of the at least one optical marker 16a is any desired additional information that in particular replaces naturally only statistical group information without having to access the database 24 for this purpose. In the example of FIG. 5, the at least one optical marker 16a is simply larger to facilitate the accuracy and robustness of the above-discussed pose determination. This effect can also be achieved by arrangements and other graphical elements, including the possibility that a different coding is used, i.e. for example not an AprilTag. The at least one optical marker 16a furthermore advantageously simultaneously acts as a symmetry breaker.

FIG. 6 shows an exemplary representation of an alternative arrangement of optical markers 16a-d from two code families. The total arrangement of the markers 16a-d forms a now somewhat differently understood group 14a. For in this case, the optical marker 16d of the second code family is not part of the actual group 14 and consequently does not contribute to the combination code while the at least one market 16a of FIG. 5 adopts a dual function also as part of the combination code.

1. A method of self-localization in a navigation environment in which a respective optical marker is attached at a plurality of positions, wherein a marker is detected and read by an optical code reader and its position is determined from the code content of the marker,
wherein the markers are attached in groups of at least three respective markers; wherein a value range of the code content of the markers is smaller than the number of positions having an optical marker; and
wherein the code content of the at least three markers of a group together uniquely describe the position of the group.

2. The method in accordance with claim 1,
wherein the navigation environment is divided into a plurality of cells and a respective group of markers is associated with the cells.

3. The method in accordance with claim 2,
wherein the navigation environment is divided into a grid.

4. The method in accordance with claim 1,
wherein a pose of the code reader is determined with respect to a detected marker to determine an offset from the position described by the group of markers.

5. The method in accordance with claim 4,
wherein the pose is determined multiple times for a plurality of the markers of a group.

6. The method in accordance with claim 5,
wherein the plurality comprises all of the markers of a group.

7. The method in accordance with claim 1,
wherein the code content of the at least three markers of a group is combined to at least one triple tuple.

8. The method in accordance with claim 7,
wherein the code content of the at least three markers of a group is combined to at least one triple tuple without taking account of the order.

9. The method in accordance with claim 1,
wherein the code content of at least one marker of a group contains a further piece of information that goes beyond the unique describing of the position by the other markers of the group.

10. The method in accordance with claim 1,
wherein the markers are at least partially displayed on a variable display.

11. The method in accordance with claim 1,
wherein an additional piece of information is queried from a database, with the code content of the at least three markers of a group.

12. The method in accordance with claim 11,
wherein the database is a database in a cloud.

13. The method in accordance with claim 11,
wherein the database provides at least one piece of the following group information on a position described with a group of at least three markers: a closer description of the position or its environment, an offset of the group of at least three markers on the position described thereby, at least one navigation rule.

14. The method in accordance with claim 13,
wherein the navigation rule comprises at least one of the following instructions: a direction indication, a distance indication, a speed specification, a prompt to pick or place an object, a prompt to recharge a battery.

15. The method in accordance with claim 11,
wherein at least one piece of group information of the database is dynamically varied.

16. The method in accordance with claim 15,
wherein the at least one piece of group information of the database is dynamically varied to respond to a current task, to persons, or to vehicles in the navigation environment.

17. A self-localizing vehicle in a navigation environment in which a respective optical marker is attached to a plurality of positions, wherein the vehicle has an optical code reader for detecting the markers and a control and evaluation unit that is configured to determine the position of a detected marker by means of the code content thereof and thus to carry out a self-localization of the vehicle,
wherein the markers are attached in groups of at least three respective markers; wherein a value range of the code content of the markers is smaller than the number of positions having an optical marker; and
wherein the code content of the at least three markers of a group together uniquely describe the position of the group.
